(19) United States
(12) Patent Application Publication
(10) Pub. No.: US 2020/0219200 A1
(43) Pub. Date: Jul. 9, 2020

(54) A Method and System for Generating a Quotation

(71) Applicant: Munich Re Automation Solutions Limited, Dublin 18 (IE)

(72) Inventors: Colm KENNEDY, County Meath (IE); Paul TRAYERS, Dublin 15 (IE); Glenn LAMBKIN, Dublin 18 (IE)

(73) Assignee: Munich Re Automation Solutions Limited, Dublin 18 (IE)

(21) Appl. No.: 16/633,015

(22) PCT Filed: Jul. 20, 2018
(86) PCT No.: PCT/EP2018/069755

§ 371 Date: Jan. 22, 2020

Related U.S. Application Data
(60) Provisional application No. 62/536,394, filed on Jul. 24, 2017.

(51) Int. Cl. G06Q 40/08

(52) U.S. Cl. CPC G06Q 40/08

(57) ABSTRACT

A computer-implemented method for generating a quotation is described. The method comprises receiving data inputs from a user; generating a structured text statement from the data inputs; generating a request containing the structure text statement; relaying the request to at least one platform which have an associated ruleset; apply at least a subset of the ruleset of the respective platform to the structured text statement to determine probable outcomes; and generating a graphical representation on a visual display, indicating the likelihood of an outcome.

### FIELD OF THE INVENTION

The present disclosure relates to a method and system for generating a quotation. In particular but not exclusively, the present disclosure relates to the generation of insurance quotations.

### SUMMARY

The present disclosure relates to a computer-implemented method for generating a quotation, the method comprising:
receiving data inputs from a user;
generating a structured text statement from the data inputs;
generating a request containing the structured text statement;
relaying the request to at least one platform which have an associated ruleset;
applying at least a subset of the ruleset of the respective platform to the structured text statement to determine probable outcomes; and
generating a graphical representation on a visual display, indicating the likelihood of an outcome.

In one aspect, the data inputs are received via a questionnaire on a graphical user interface.

The present disclosure also relates to a system for generating a quotation, the comprising one or modules being operable for:
receiving data inputs from a user;
generating a structured text statement from the data inputs;
generating a request containing the structured text statement;
relaying the request to at least one platform which have an associated ruleset;
applying at least a subset of the ruleset of the respective platform to the structured text statement to determine probable outcomes; and
generating a graphical representation on a visual display, indicating the likelihood of an outcome.

In one aspect, one of the modules is a questionnaire user interface.

In another aspect, one of the modules comprises a discovery module configured to determine a range of outcomes based on the received data inputs.

In one aspect, one of the modules is a mapping module which is in communication with a mapping repository.

In a further aspect, language processing techniques are used to change free text emails into the structured text statement.

In another aspect, a baseline outcome is retrieved from a decision engine via an application programming interface.

In one aspect, the decision engine looks up the ruleset to identify rules that are compatible with the data inputs received from the user.

In another aspect, the decision engine generates the subset of rules from the identified rules and applies the subset of rule to determine probable outcomes.

In a further aspect, the mapping module uses Domain Specific Language.

The present disclosure also relates to an article of manufacture comprising a processor-readable medium having embodied therein executable program code that when executed by the processing device causes the processing device to perform:
receiving data inputs from a user;
generating a structured text statement;
generating a request containing the structured text statement;
relaying the request to at least one platform which have an associated ruleset;
applying at least a subset of the ruleset of the respective platform to the structured text statement to determine probable outcomes; and
generating a graphical representation on a visual display, indicating the likelihood of an outcome.

In one aspect, the present teaching relates to a computer-implemented method for generating a quotation, the method comprising:
receiving data inputs from a user;
generating a structured text statement;
generating a request containing the structured text statement;
relaying the request to at least one carrier which have an associated ruleset;
apply the rules of the respective carriers to the structured text statement and determines a feasible outcome statistical range by mapping carrier rulebook nodes to structured text data;
determine the likelihood of each endpoint in the carriers ruleset being reached; and apply probabilities to a subset of outcomes remaining as theoretically possible.

The present disclosure also relates to a system for generating a quotation, the comprising one or modules being operable for:
receiving data inputs from a user;
generating a structured text statement;
generating a request containing the structured text statement;
relaying the request to at least one carrier which have an associated ruleset;
applying the rules of the respective carriers to the structured text statement and determines a feasible outcome statistical range by mapping carrier rulebook nodes to structured text data;
determine the likelihood of each endpoint in the carriers ruleset being reached; and
apply probabilities to a subset of outcomes remaining as theoretically possible.

Additionally, the present disclosure relates to an article of manufacture comprising a processor-readable medium having embodied therein executable program code that when executed by the processing device causes the processing device to perform:
receiving data inputs from a user;
generating a structured text statement;
generating a request containing the structured text statement;
relaying the request to at least one carrier which have an associated ruleset;
applying the rules of the respective carriers to the structured text statement and determines a feasible outcome statistical range by mapping carrier rulebook nodes to structured text data;
determine the likelihood of each endpoint in the carriers ruleset being reached; and
apply probabilities to a subset of outcomes remaining as theoretically possible.

### BRIEF DESCRIPTION OF THE DRAWINGS

The present teaching will now be described with reference to the accompanying drawings in which:

FIG. 1 is a block diagram of a system for generating a quotation in accordance with the present teaching.

FIG. 2A is an exemplary detail of the system of FIG. 1.

FIG. 2B is an exemplary detail of the system of FIG. 1.

FIG. 3 is an exemplary detail of the system of FIG. 1

FIG. 4 is a flow chart detailing exemplary steps for generating a quotation which may be implemented by the system of FIG. 1.

FIG. 5 is a flow chart detailing exemplary steps for generating a quotation which may be implemented by the system of FIG. 1.

FIGS. 6A-6C are graphical representations of a decision tree logic implemented by the system of FIG. 1.

FIG. 7 is a flowchart illustrating exemplary steps for generating a quotation.

### DETAILED DESCRIPTION OF THE DRAWINGS

The present teaching will now be described with reference to a system for generating a quotation. It will be understood that the exemplary system is provided to assist in an understanding of the present teaching and is not to be construed as limiting in any fashion. Furthermore, modules or elements that are described with reference to any one Figure may be interchanged with those of other Figures or other equivalent elements without departing from the spirit of the present teaching. The following glossary of terms are provided to aid an understanding of present disclosure and are not to be construed as limiting in any fashion.

Underwriting Philosophy: The view a life insurance company takes when it comes to accessing risk. Some insurance companies ask for many data points, some ask for less in order to make a decision on whether the case in insurable at standard or other rates.

Disclosure: When information is supplied for risk assessment purposes it is called a disclosure. Disclosures are made by or on behalf of the Life insurance applicant. E.g. “I Have Asthma” or “My client has Asthma”.

Outcome: The underwriting result for a quotation.

Carrier: A Life insurance Company.

Quotation: A life insurance quotation based on some but not all Case information. This is not a formal Life insurance Application.

Case: A formal Life insurance Application.

Rulebook: A rulebook is an electronic file that contains underwriting rules or logic in digital format so that it can be interpreted by software.

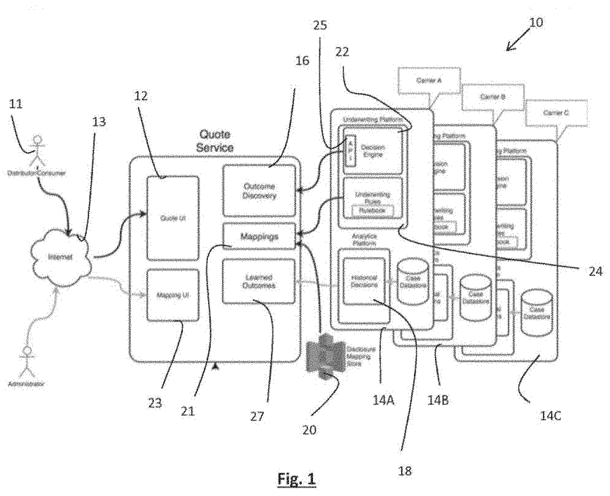

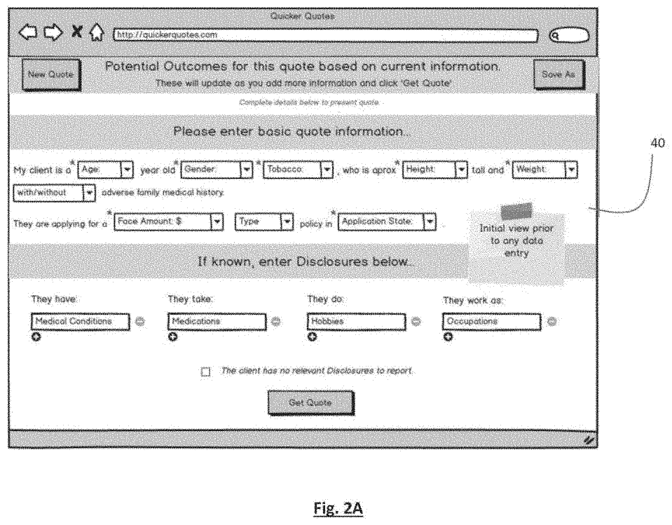

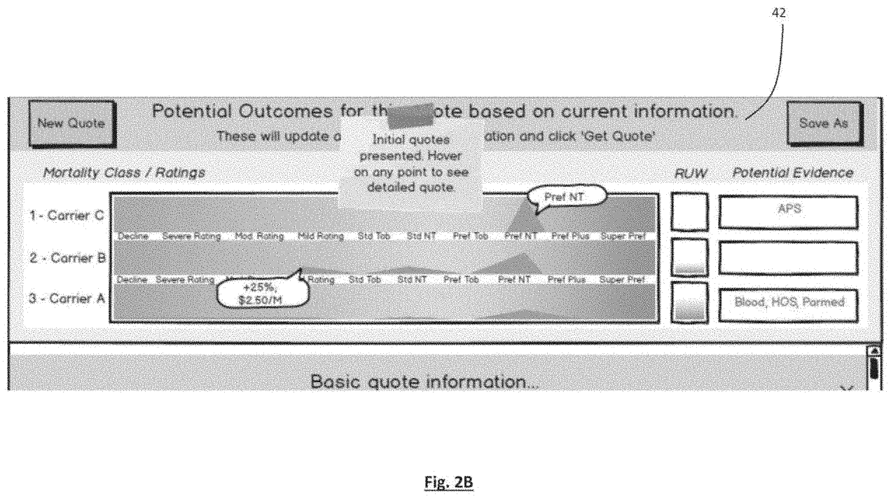

Referring to drawings and, in particular to FIG. 1, an exemplary quotation generation system 10 is illustrated. The usage of the system 10 starts with a user 11 accessing the quotation user interface (UI) 12 through the internet 13 on a client device, for example, a laptop, tablet or smart device. The quotation UI 12 requests client information, for example, height weight and any disclosures using a questionnaire 40 as illustrated in FIG. 2. In the exemplary embodiment, the questionnaire includes drop down menus that the user can selects answers to questions. The client information gathered via the questionnaire 40 is used to determine a range of outcomes from the one or more underwriting platforms 14A-14C through an outcome discovery module 16. The outcome discovery module 16 is configured to make sense of the client information in the context of each carriers underwriting rules using a mappings module 18 which is in communication with a disclosure mapping store 20. The outcome discovery module 16 communicates with to the underwriting platforms 14A-14C through a decision engine 22. Once the outcomes have been retrieved they can be displayed on the quotation UI 12 in the form of one or more spectrographs 42 as illustrated in FIG. 2B.

The process of capturing client information and refining outcomes down from a range to a single outcome is an iterative one. Each time more information is supplied the range narrows down further. Mappings 21 provide a common understanding between the data supplied from the quotation UI 12 and each carriers rulebook data 24. The mapping UI 23 allows the user to link quotation UI data to a carriers rulebook data. Mappings are done per Disclosure. The mappings 21 are stored in their own proprietary language. Each disclosure also has a distribution of outcomes. The outcomes are learned from the carriers historical decisions 18 and can be overridden from the mapping UI 23.

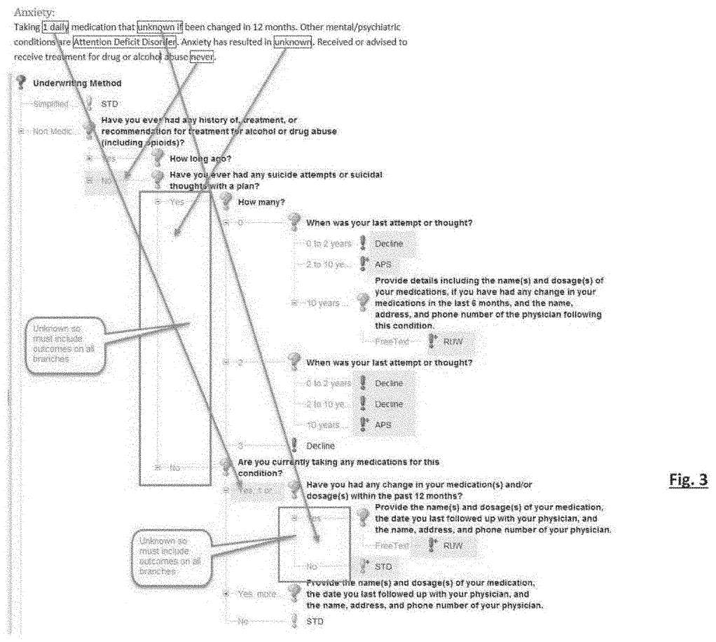

The input data received from the user is translated into a structured text statement. An exemplay structured text statement is illustrated in FIG. 3 which recites:

“Taking 1 daily medication that unknow if been changed in 12 months. Other mental/psychiatric conditions are Attention Deficit Disorder. Axiety has resulted in unknow. Received or advised to receive treatment for drug or alcohol abuse never.”

The structured text statement is relayed to the outcome discovery module 16 which looks up the existing carrier databases of real underwriting applications and determines the likelihood of each endpoint in the carriers rulebook being reached. The outcome discovery module 16 learns this from the real rule book and real cases and applies the probabilities to a subset of outcomes remaining as theoretically possible.

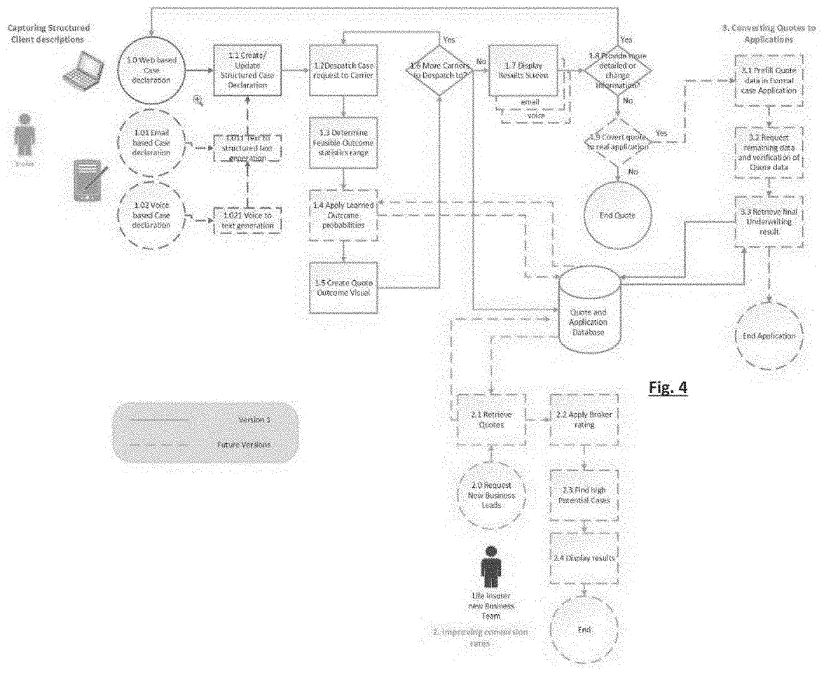

FIG. 4 is an exempalry flowchart illustrating exemplary steps implemented by the system 10. Information from a client is captured from an input module which may include a web based module, block 1, an email based module, block 1.01 or a voice base module, block 1.02. It will be appreciated that the input module may include a combination of blocks 1.0, 1.01 and 1.02 or just one. In the scenario where the input module 105 include the voice based module, the voice data received from the user is generated into text, block 1.021. In the scenario that the input module receives information from users via eamil, the text in the email are formated into a structured statement, block 1.011.

Step 1.011 Free Text to Structured Text Generation

A proprietary dictionary of medical and underwriting terms along with natural language processing techniques may be used to change free text emails into structured data that can be used in 1.1.

Step 1.3 Determine Feasible Outcome Statistics Range

Deals with impartial information by using available information to rule out underwriting outcomes that are not theoretically possible based on the Insurance carriers underwriting electronic ruleset. With the outcomes that are theoretically remaining it measures their frequency.

Step 1.3.1 Providing a Baseline Outcome

Using basic information from the applicant, e.g. age, amount, height, weight, etc. a baseline outcome is retrieved from the decision engine 22 via an application programming interface (API) 25. The API 25 looks up the rulebook 24 to see which rules consider this baseline information. Once the rules that are involved are identified, the potential outcomes from these rules are examined. The potential outcomes form the range displayed on the User Interface as illustrated in FIG. 2B.

Step 1.3.2 Discovering Outcomes from Disclosed Information

Using the information provided by the applicant in the questionnaire 40, further possible outcomes are discovered with the approach below.

Step 1.3.2.1 Mapping Answers

Each carrier captures their underwriting philosophy in a rulebook, the decision engine utilises the rulebook to provide decisions and decision trees via an API endpoint. The information required by the decision engine 22 may vary from carrier to carrier. A domain specific language transforms answers from the questionnaire into the API 25 to answer carrier specific questions. This is illustrated in the Architecture diagram as the mapping 21.

A mapping is structured by the Domain Specific Language in three sections, namely, paths, options and answers. Paths unlock the path through the decision tree to the data point in the Carriers rulebook. Options are the possible answers that exist in the carriers rulebook. Answers are the mapping of the carrier rulebook options to the quotation UI data points.

An Example of the DSL mapping the questionnaire to a carrier specific question is provided below by way of example.

Question: “In the last 2 years, have you required oral steroids (such as Prednisone)?”

a. Paths:

“//decisionTree/reflexiveQuestion/branches/branch[1]/reflexiveQuestion/branches/branch[2]/reflexiveQuestion/branches/branch[2]/reflexiveQuestion”

“//decisionTree/reflexiveQuestion/branches/branch[1]/reflexiveQuestion/branches/branch[3]reflexiveQuestion/branches/branch[2]/reflexiveQuestion”

“//decisionTree/reflexiveQuestion/branches/branch[2]/reflexiveQuestion/branches/branch[2]/reflexiveQuestion”
Options:
“Yes”
“No”
Answers:
“Yes” if {{oralSteroids}}=“daily,”
“Yes” if {{oralSteroids}}=“within the last 2 yrs,”
“No” if {{oralSteroids} }=“not within the last 2 yrs,”

In the example the carrier specific question “In the last 2 years, have you required oral steroids (such as Prednisone)?” is identified uniquely by the xpaths as specified in the Paths section.

There are two possible answers that can be supplied to the API 25 for the carrier specific question.

The Answers section covers how the mapping is performed, in this case a questionnaire variable “oralSteroids” contains three possible answers “daily”, “within the last 2 yrs,” and “not within the last 2 yrs,”, so for example if the user selects “daily,” then the answer supplied for this question to the API will be “Yes”.

Step 1.3.2.2 Discovering Outcomes from Disclosures

Each carrier defines a set of rules per disclosure in the form of a decision tree with outcomes provided on the leaf nodes of the tree (these are denoted by rectangles in the diagram), non leaf nodes are decision points (denoted by circles in the diagram). The architecture diagram shows this as the outcome discovery module 16.

The decision tree minus outcomes is available from the decision engine 22. In order to decide which questions to answer perform the following:
Traverse the tree using a tree recursion algorithm.
At each decision point determine if the information has been provided to answer the question
   Determine if information has been provided
   If the information has been provided then record this and continue the traversal down the decision branch.
   If the information has not been provided then duplicate the record of answers and repeat the examination of the current node for all possible answers.
By the time a leaf node is reached, all questions that need to be answered have been discovered.
For each set of answers:
   Translate the questionnaire answers into carrier specific answers using the mapping feature described above.
   Call the decision API 25 with the set of answers to determine the outcome.
   Record the outcome.

A case request containing the structurd statement is relayed by the discovery module 16 to the underwriter platforms. The discovery module 16 applies the rules of the respective carriers and determines a feasible outcome statistical range, block 1.3. This is achieved by mapping carrier rulebook nodes to structured case data gathered in the user interface. Block 1.3 deals with incomplete information by using available information to rule out underwriting outcomes that are not theoretically possible based on the insurance carriers underwriting electronic ruleset. With the outcomes that are theoretically remaining it measures their frequency.

The learned outcomes module 27 applies a learned outcome probabilities, block 1.4. The learned outcomes module 27 may look up the existing carrier database of real underwriting applications and determines the likelihood of each endpoint in the carriers rulebook being reached. The learned outcomes module 27 may learn this from the real rule book and real cases and applies the probabilities to subset of outcomes remaining as theoretically possible as determined in step 1.3.

A quotation 120 is generated and a graphical representation is generated as illustrated in FIG. 2B. The steps of blocks 1.2, 1.3, 1.4 and 1.5 is repeated for each of the carriers 14A-14C, block 1.6. The quotation containing the outcome for each carrier 14A-14C is visually displayed on a visual display unit, block 1.7. The visual display may illustrate a range of outcomes and their likelihood to be arrived at. Block 1.8 allows users to modify or provide additional information. Once the quotation has been finalised the user may then convert the quotation to an application, block 1.9.

The quotation may be converted into an application by automatically populating the application with the information that the user has already provided. This process of converting a quotation to an application may include the following steps for example, prefill quotation data into formal case application, block 31. Request remaining data and verification of quotation data, block 3.2. Retrieve final underwriting results, block 3.3. A proprietary algorithm to rank brokers based on placement rates and case value is used in block 2.2. It will be used in combination with existing information on case value to advise the carriers about the best New business opportunities to work on.

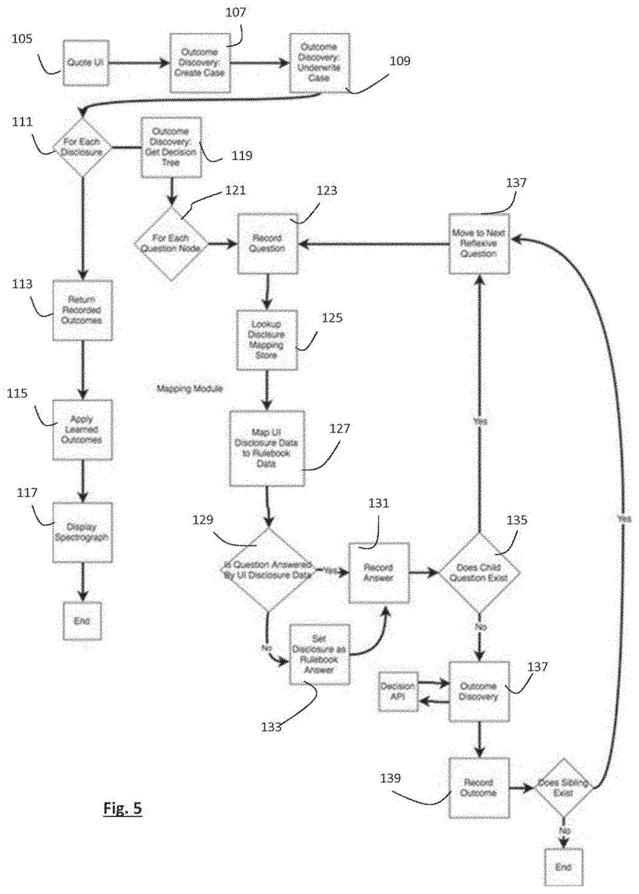

Referring to the flow chart 100 of FIG. 5 which further illustrates steps 1.3, 1.4 and 1.5 of FIG. 3. The flow chart 100 shows how User Disclosures are gathered through the Quotation UI, they mapped to rulebook data, a range of feasible outcomes determined, then a spectrograph is displayed. Information is gathered from a user via questionnaire 40 via Quotation UI, step 105. The outcome discovery module creates a case for the user, step 107. The outcome discovery module communicates the case to underwriter platforms, step 109. For each disclosure, an iterative process is initiated, step 111. The discovery module returns a recorded outcome from historical data from the underwriter platform, step 113. A learned outcomes module 27 looks up the existing carrier database of real underwriting applications and determines the likelihood of each endpoint in the carriers rulebook being reached. The learned outcomes module 27 module is configured to learn this from the real rule book and real cases and applies the probabilities to a subset of outcomes remaining as theoretically possible, step 115.

A spectrograph is displayed on a visual display unit showing the outcomes; step 119. For each disclosure, the outcome discovery module applies decision tree logic, step 119. For each question node, an iterative process is initiated, step 121. Each question is recorded, step 123. The outcome discovery module 16 is configured to make sense of the client information in the context of each carriers underwriting rules using the mappings module which references the disclosure mapping store 20, step 125. Map UI disclosure data to rule book data, step 127. Determine if the question is answered by UI disclosure data, step 129. If the question is answered, the answer is recorded, step 131. If it is determined that the Question is not answered, a rulebook answer from the underwriter is applied, step 133. The rulebook answer is stored, step 131. Determine if a child question exists, step 135. If a child question exists, steps 123, 125, 127, 129, 131, and 133 are applied to the next question, step 137. If there are no child questions, a baseline outcome is retrieved from the decision engine 22, step 137 22 via an application programming interface 25 (API). The decision API 25 looks up the rulebook to see which rules consider this baseline information. Once the rules that are involved are identified, the potential outcomes from these rules are examined. The discovered outcome is recorded, step 139.

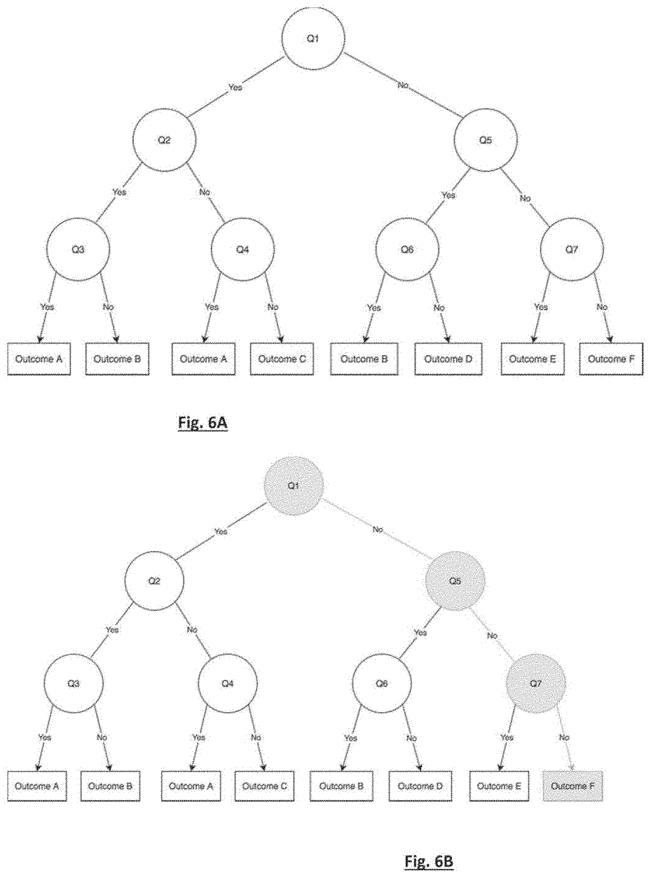

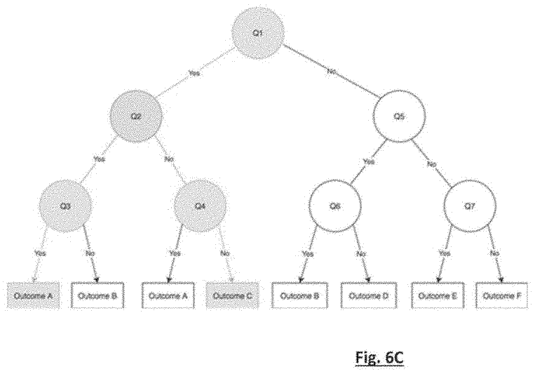

Referring to FIGS. 6A-6C which diagrammatically illustrates a tree of seven questions, Q1-Q7. Outcome F is reached as illustrated in FIG. 6B by answering the questions as follows:
Q1 No
Q5 No
Q7 No

When a question is left unanswered as illustrated in FIG. 6C then all outcomes become possible as the node is traversed with all possible outcomes:
Q1 Yes
Q2 Unanswered
Q3 Yes
Q4 No

Result: Both outcomes “Outcome A” and “Outcome C” are returned to the user as possibilities.

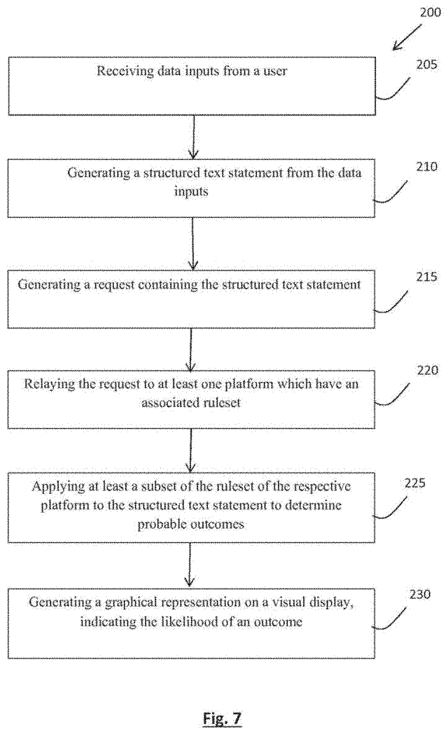

FIG. 7 is shows a flow diagram 200 illustrating an exemplary method for generating a quotation. The method 200 may be implemented by one or more processors. The method comprises the steps of receiving data inputs from a user, block 205; generating a structured text statement from the data inputs, block 210; generating a request containing the structured text statement, block 215; relaying the request to at least one platform which have an associated ruleset; block 220, applying at least a subset of the ruleset of the respective platform to the structured text statement to determine probable outcomes, block 230; and generating a graphical representation on a visual display, indicating the likelihood of an outcome.

It will be understood that what has been described herein is an exemplary system and method for generating a quotation. While the present teaching has been described with reference to exemplary arrangements it will be understood that it is not intended to limit the teaching to such arrangements as modifications can be made without departing from the spirit and scope of the present teaching. The method of the present teaching may be implemented in software, firmware, hardware, or a combination thereof. In one mode, the method is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. The steps of the method may be implemented by a server or computer in which the software modules reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the Quote UI 12, outcome discovery module 16, mapping UI 23, learned outcomes module 27, decision engine 22 as described above. The processor(s) is a hardware device for executing software, particularly software stored in memory. Processor(s) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions.

Memory is associated with processor(s) and can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules. In the example of heretofore described, the software in memory includes the one or more components of the method and is executable on a suitable operating system (O/S).

The present teaching may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

When the method is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. Any process descriptions or blocks in the Figures, should be understood as representing modules, segments, or portions of code which include one or more executable instructions for implementing specific logical functions or steps in the process, as would be understood by those having ordinary skill in the art.

It should be emphasized that the above-described embodiments of the present teaching, particularly, any “preferred” embodiments, are possible examples of implementations, merely set forth for a clear understanding of the principles. Many variations and modifications may be made to the above-described embodiment(s) without substantially departing from the spirit and principles of the present teaching. All such modifications are intended to be included herein within the scope of this disclosure and the present invention and protected by the following claims.

While the present teaching has been described with reference to exemplary applications and modules it will be understood that it is not intended to limit the teaching of the present teaching to such arrangements as modifications can be made without departing from the spirit and scope of the present invention. In this way it will be understood that the present teaching is to be limited only insofar as is deemed necessary in the light of the appended claims.

Similarly the words comprises/comprising when used in the specification are used to specify the presence of stated features, integers, steps or components but do not preclude the presence or addition of one or more additional features, integers, steps, components or groups thereof.

1. A computer-implemented method for generating a quotation, the method comprising:
receiving data inputs from a user;
generating a structured text statement from the data inputs;
generating a request containing the structured text statement;
relaying the request to at least one platform which have an associated ruleset;
applying at least a subset of the ruleset of the respective platform to the structured text statement to determine probable outcomes; and
generating a graphical representation on a visual display, indicating the likelihood of an outcome.

2. The method of claim 1; wherein the data inputs are received via a questionnaire on a graphical user interface.

3. The method of claim 1; wherein decision tree logic is applied when determining probable outcomes.

4. The method of claim 1; wherein language processing techniques are used to change free text emails into the structured text statement.

5. The method of claim 1; wherein a baseline outcome is retrieved from a decision engine via an application programming interface.

6. The method of claim 5; wherein the decision engine looks up the ruleset to identify rules that are compatible with the data inputs received from the user.

7. The method of claim 6; wherein the decision engine generates the subset of rules from the identified rules and applies the subset of rule to determine probable outcomes.

8. A system for generating a quotation, the system comprising one or modules being operable for:
receiving data inputs from a user;
generating a structured text statement from the data inputs;
generating a request containing the structured text statement;
relaying the request to at least one platform which have an associated ruleset;
applying at least a subset of the ruleset of the respective platform to the structured text statement to determine probable outcomes; and
generating a graphical representation on a visual display, indicating the likelihood of an outcome.

9. The system of claim 8; wherein one of the modules is a questionnaire user interface.

10. The system of claim 8; wherein one of the modules comprises a discovery module configured to determine a range of outcomes based on the received data inputs.

11. The system of claim 10; wherein one of the modules is a mapping module which is in communication with a mapping repository.

12. The system of claim 8; wherein language processing techniques are used to change free text emails into the structured statement.

13. The system of claim 8; wherein a baseline outcome is retrieved from a decision engine via an application programming interface.

14. The system of claim 13; wherein the decision engine looks up the ruleset to identify rules that are compatible with the data inputs received from the user.

15. The system of claim 14; wherein the decision engine generates a subset of rules from the identified rules and applies the subset of rule to determine probable outcomes.

16. The system of claim 11; wherein the mapping module uses Domain Specific Language.

17. An article of manufacture comprising a processor-readable medium having embodied therein executable program code that when executed by the processing device causes the processing device to perform:
receiving data inputs from a user;
generating a structured text statement;
generating a request containing the structured text statement;
relaying the request to at least one platform which have an associated ruleset;
apply at least a subset of he ruleset of the respective platform to the structured text statement to determine probable outcomes; and
generating a graphical representation on a visual display, indicating the likelihood of an outcome.
